(19) United States
(12) Patent Application Publication
(10) Pub. No.: US 2026/0172091 A1
(43) Pub. Date: Jun. 18, 2026

(54) CSI REFERENCE RESOURCES FOR APERIODIC CSI REPORTING

(71) Applicant: Apple Inc., Cupertino, CA (US)

(72) Inventors: Haitong Sun, San Jose, CA (US); Dawei Zhang, Saratoga, CA (US); Wei Zeng, Saratoga, CA (US); Ismael Gutierrez Gonzalez, San Jose, CA (US); Ghaith N Hattab, Santa Clara, CA (US); Weidong Yang, San Diego, CA (US); David Neumann, Munchen (DE); Yeong-Sun Hwang, Germering, Baveria-Bayern (DE)

(21) Appl. No.: 19/125,357

(22) PCT Filed: Oct. 17, 2023
(86) PCT No.: PCT/US2023/035278

§ 371 Date: Apr. 29, 2025

Related U.S. Application Data
(60) Provisional application No. 63/422,860, filed on Nov. 4, 2022.

(51) Int. Cl. H04B 7/06; H04L 27/26; H04W 24/10

(52) U.S. Cl. CPC H04B 7/0626; H04L 27/26025; H04W 24/10

(57) ABSTRACT

Techniques discussed herein can facilitate aperiodic channel state information (CSI) reporting based on periodic and semi-persistent measurement resources by determining a scheduling gap for aperiodic CSI reporting. One example aspect is a user equipment (UE), including a memory; and one or more processors configured to, when executing instructions stored in the memory, cause the UE to receive configuration of an aperiodic channel state information (CSI) report, where the configuration indicates one or more CSI measurement resources; determine a scheduling gap based on a rule associated with the configuration, where the scheduling gap is a minimum time period between receiving the one or more CSI measurement resources and transmitting the aperiodic CSI report; generate the aperiodic CSI report based on CSI measurement resources of the one or more CSI measurement resources received prior to the scheduling gap; and transmit the aperiodic CSI report according to the configuration.

### REFERENCE TO RELATED APPLICATIONS

This Application claims the benefit of U.S. Provisional Application No. 63/422,860, filed on Nov. 4, 2022, the contents of which are hereby incorporated by reference in their entirety FIELD

The present disclosure relates to wireless communication networks and mobile device capabilities.

### BACKGROUND

Mobile communication in the next generation wireless communication system, 5G, new radio (NR), sixth generation technology, and so on will provide ubiquitous connectivity and access to information, as well as the ability to share data, around the globe. Next generation wireless communication systems provide service-based framework that will target to meet versatile, and sometimes conflicting, performance criteria. Such technology may include solutions for enabling user equipment (UE) to perform measurement reporting based on a periodicity of measurement resources.

### BRIEF DESCRIPTION OF THE DRAWINGS

FIG. 1 is an example diagram of a wireless network where wireless communication devices configure and facilitate channel state information (CSI), measurements, and reporting.

FIGS. 2-4 are timing diagrams illustrating example aperiodic CSI reporting with periodic and/or semi-persistent CSI measurement resources.

FIG. 5 is a timing diagram illustrating valid CSI measurement resources and invalid CSI measurement resources.

FIG. 6 illustrates a diagram for backward compatibility for aperiodic CSI reporting.

FIG. 7 is a flow diagram outlining an example method by which a user equipment (UE) performs aperiodic CSI reporting.

FIG. 8 is a flow diagram outlining an example method by which a base station (BS) configures aperiodic CSI reporting.

FIG. 9 is a diagram of an example of components of a device according to one or more implementations described herein.

FIG. 10 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The present disclosure is described with reference to the attached figures. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events.

Furthermore, not all illustrated acts or events are required to implement a methodology in accordance with the selected present disclosure.

The present disclosure relates to aperiodic channel state information (CSI) reporting based on periodic and semi-persistent measurement resources.

Techniques discussed herein are directed towards determining a scheduling gap that sets a minimum duration between a last downlink (DL) slot that a configured CSI measurement resource may be scheduled and a transmission time of an aperiodic CSI report. Solutions discussed herein achieve faster communications with higher throughput by minimizing the scheduling gap.

Wireless networks rely on the known channel properties of a communication link to maintain reliable wireless connections between a user equipment (UE) and a base station (BS). The BS may configure measurement resources in a CSI request.

Configured measurement resources may include signals that the UE can measure to determine channel conditions or interference levels. The UE may then send reports based on the channel measurements to the BS, where such reports may be in accordance with a CSI request for an aperiodic CSI report, for example. The UE performs measurements according to the configured CSI measurement resources and transmits a CSI report to the BS based on the measurements. The CSI report may include channel properties including a channel quality indicator (CQ), rank indicator (RI), precoding matrix indicators (PMI), reference signal received power (RSRP), and the like. The BS and the UE may use the known channel properties from the CSI report to facilitate beam management, resolve radio link failure (RLF) or beam feature (BF) through beam recovery, fine tuning time and frequency synchronization, perform link adaptation, or other wireless link operations.

The BS may configure the UE for different time domain reporting behaviors for the CSI report, where the UE may be configured for aperiodic, semi-persistent, or periodic CSI reporting based on configured CSI measurement resources. When the UE is configured for CSI reporting, a CSI reference resource is determined based on the CSI configuration from the BS. The CSI reference resource is the last downlink (DL) slot that a CSI measurement resource may be configured to allow the UE time after receiving a last CSI measurement resource to complete CSI measurement, computations, and compile the CSI report. As such, a scheduling gap is determined as the minimum time between the end of the CSI reference resource and a scheduled time to transmit the CSI report. To realize efficient use of resources, the scheduling gap may be determined based on a subcarrier spacing (SCS) of a configured resource that may include the CSI measurement resource.

Presently, aperiodic CSI measurement resources are considered in determining the scheduling gap for aperiodic CSI reporting, while periodic or semi-persistent CSI measurement resources are not considered. As such, aspects presented herein provide throughput enhancements and enhanced time scheduling for aperiodic CSI reporting based on periodic or semi-persistent CSI measurement resources.

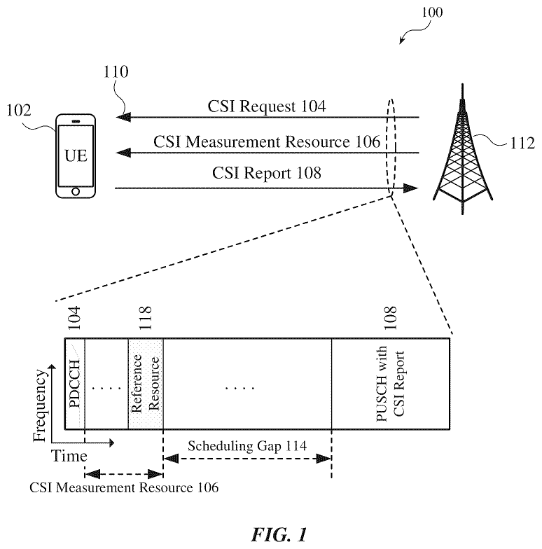

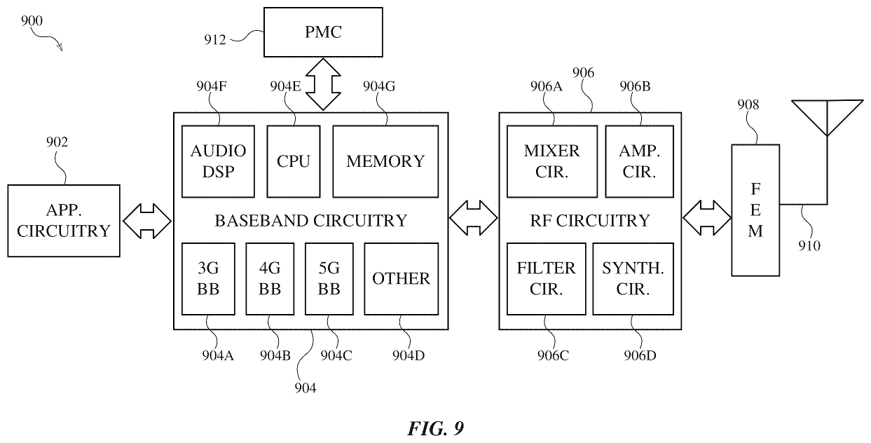

FIG. 1 illustrates an example diagram 100 of a wireless network where wireless communication devices (e.g., a UE 102, a BS 112, or generic devices) configure and facilitate CSI measurements and reporting. The UE 102 in the network includes baseband circuitry that includes one or more processors configured to perform various types of communications related to CSI. For the purposes of this description, when a “UE,” “BS,” or “device” is described as performing some function, it may be understood that it is the processor(s) in the baseband circuitry, in conjunction with memory and/or transceivers(s), in some instances that performs the function. An example wireless communication device, including baseband circuitry, is illustrated in more detail in FIG. 9.

The example diagram 100 shows signaling for CSI configuration, measurements, and reporting over an air interface 110. The BS 112 can transmit downlink (DL) information to the UE 102 over the air interface 110, and the UE 102 can transmit uplink (UL) information to the BS 112 over the air interface 110. The BS 112 sends a CSI request 104 to the UE 102. The CSI request 104 can indicate a CSI report configuration and a CSI measurement resource configuration. The CSI request 104 can be comprised in a downlink control information (DCI) of a physical downlink control channel (PDCCH) messaging. For example, the CSI request 104 can be indicated by a DCI format 0_1 or DCI format 0_2. The CSI request 104 can configure the UE 102 for aperiodic or semi-persistent CSI reporting. In other aspects, the UE 102 can receive radio resource control (RRC) signaling to configure periodic CSI reporting, for example, through a reportConfigType RRC configuration.

The configured CSI measurement resources may be, for example, periodic, aperiodic, or semi-persistent. The CSI measurement resources may include a non-zero power CSI reference signal (NZP-CSI-RS) for channel measurements, a NZP-CSI-RS for interference measurements, a CSI interference measurement (CSI-IM) resource for interference measurement, or a synchronization signal block (SSB) for channel measurement. The NZP-CSI-RS for channel measurements and SSB may be referred to generally as channel measurement resources (CMRs). Furthermore, the UE 102 may perform reference signal receive quality (RSRQ), noise and interference ratio (SINR) measurements, or the like associated with the SSB.

The NZP-CSI-RS for interference measurements and other CSI measurement resources used to determine interference (e.g., CSI-IM) may be referred to generally as interference measurement resources (IMRs). IMRs may be used to make signal to noise ratio (SNR) measurements to determine a channel quality indicator (CQ). The CSI-IM resource can be configured to determine channel characteristics in the presence of inter-cell interference, thermal noise, or multiple input multiple output (MIMO) communications, where the serving cell (e.g., BS 112) may be configured not to transmit on configured resource elements while the UE 102 measures background interference. The NZP-CSI-RS for interference measurements can be configured for the UE 102 to measure interference generated by transmissions from neighboring devices. The NZP-CSI-RS for channel measurements can be configured for beam management.

The BS 112 and the UE 102 determine a reference resource 118 and a scheduling gap 114 based on the CSI configuration. The scheduling gap 114 is to allow time for the UE to compile the CSI report after conducting measurements of the CSI measurement resources. The scheduling gap is determined based at least on a minimum SCS of the PDCCH in which the CSI request is transmitted, an SCS of a PUSCH with which the CSI report is to be transmitted, a minimum SCS of an aperiodic CSI-RS configured by the CSI request, or any combination of the above. The reference resource 118 is determined based on the last DL slot in which a CSI measurement resource can be measured by the UE and still allow the UE to generate and transmit the CSI report in accordance with the scheduled timing of the CSI report.

After transmitting the CSI request 104, the BS 112 transmits one or more CSI measurement resources (e.g., CSI measurement resource(s) 106). After the UE 102 receives and measures the signals on the CSI measurement resource(s) 106, the UE 102 generates a CSI report 108. In some aspects, the CSI report 108 is generated before the scheduling gap 114. In other aspects, the CSI report 108 is scheduled during the scheduling gap. The UE transmits the CSI report 108 in a physical uplink shared channel (PUSCH) or a physical uplink control channel (PUCCH). The CSI report 108 can include channel properties described generally as CSI. The CSI can include one or more of CQI, RI, PMI, a SSB indicator (SSBRI), CSI-RS resource indicator (CRI), a layer indicator (LI), layer 1 RSRP (L1-RSRP), or the like.

According to current versions of the 3^{rd} Generation Partnership Project (3GPP) standards, the scheduling gap for an aperiodic CSI report is determined based on a minimum SCS of the following: minimum SCS of the PDCCH in which the CSI request is transmitted, an SCS of a PUSCH with which the CSI report is to be transmitted, a minimum SCS of an aperiodic CSI-RS configured by the CSI request, or any combination of the above. However, the 3GPP standards do not specify whether SCS of periodic or semi-persistent CSI measurement resources should be considered when determining the measurement gap. This means that CSI configurations for aperiodic CSI reporting may include an overly long time period between a last configured CSI measurement resource and the scheduled transmission time of the CSI report to compensate for the uncertainty in how a UE will determine the scheduling gap when periodic or semi-persistent CSI measurement resources are configured. This introduces unnecessary delay in communications and diminished throughput. As such, solutions discussed herein are directed towards determining the scheduling gap 114 for aperiodic CSI reporting with periodic or semi-persistent CSI measurement resources.

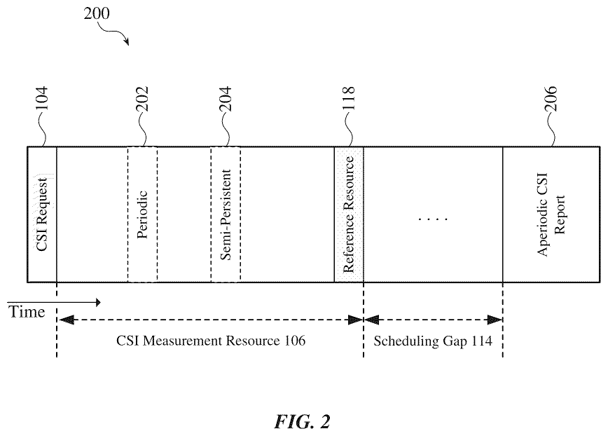

FIG. 2 illustrates a timing diagram 200 for aperiodic CSI reporting with periodic or semi-persistent CSI measurement resources. The UE 102 receives the CSI request 104 in a PDCCH message that includes a CSI configuration. The CSI configuration configures the UE 102 for an aperiodic CSI report 206. Furthermore, the example CSI configuration indicates one or more CSI measurement resources that can include one or more of a periodic CSI measurement resources 202, or a semi-persistent CSI measurement resource 204. The one or more periodic CSI measurement resources 202 may include periodic channel measurement resources (CMRs) such as, for example, SSBs and NZP-CSI-RS; and periodic interference measurement resources (IMRs) such as, for example, NZP-CSI-RS and CSI-IM.

The semi-persistent CSI measurement resource 204 may include periodic channel measurement resources (CMRs) such as, for example, NZP-CSI-RS; and semi-persistent interference measurement resources (IMRs) such as, for example, NZP-CSI-RS and CSI-IM.

The UE 102 can determine a scheduling gap 114 based on a rule associated with the CSI configuration, and determine a reference resource associated with the CSI configuration based on the scheduling gap 114. As described herein, the scheduling gap 114 is a minimum time period between the reference resource 118 and transmission of the aperiodic CSI report. The UE 102 generates the aperiodic CSI report 206 based on the one or more CSI measurement resources and transmits the aperiodic CSI report according to the CSI configuration.

The rule for determining the scheduling gap 114 can be based on a SCS of one or more of the configured CSI measurement resources. In some aspects, the rule is based on a SCS of a configured periodic CSI measurement resource or a configured semi-persistent CSI measurement resource. In other aspects, the rule can be based on a delay quantity (Z′). Z′ can be used to determine the scheduling gap 114 based on SCS of various CSI resources related to the CSI report, including the PDCCH, PUSCH, and configured CSI measurement resources according to a look up table. For example, Z′ can be a function that includes a minimum SCS of the CSI resources, where μ can represent the SCS of a CSI resource. As such, Z′ can be a function of a minimum function as described in Equation 1.

$$min ( {μ}_{P D C C H} , {μ}_{U L} , {μ}_{periodic resource} , {μ}_{s emi - persistent resource} ) \qquad Equation 1$$

Where μ_{PDCCH} is a SCS of the PDCCH carrying the CSI request 104, μ_{UL} is a SCS of the UL signaling, such as the aperiodic CSI report 206, μ_{periodic resource} is the SCS of the periodic CSI measurement resource, and μ_{semi-persistent resource} is the SCS of the semi-persistent CSI measurement resource. Equation 1 is not limited in this respect, and can include the SCS of other configured CSI measurement resources, such as an aperiodic measurement resource.

In other aspects, the rule for determining the scheduling gap 114 can be based on a function

$$( {T}_{p r o c , CSI}^{′} )$$

including Z′ as described in 3GPP Technical Specification (TS) 38.214 v17.3.0 (hereafter TS 38.214), of which the contents are referenced to herein. Section 5.4 of TS 38.214 includes Table 5.4-1 and Table 5.4-2 CSI computation delay quantities wherein Z′ is based on μ. As such, μ as described in Tables 5.4-1 and Table 5.4-2 of TS 38.214 can be modified so that Z′ may be based on the μ_{periodic resource} or μ_{semi-persistent resource} as describe herein, and the function including Z′ described in Section 5.4 of TS 38.214 can be modified so that Z′ is based on periodic or semi-persistent CSI measurement resources for the aperiodic CSI report 206.

The rule for considering one or more periodic CSI measurement resources 202 or semi-persistent CSI measurement resource 204 in determining the scheduling gap may be specified according to various options. In a first option, the rule determines the scheduling gap 114 based on both the SCS of a configured periodic CSI measurement resource and a configured semi-persistent CSI measurement resource. In a second option, the rule determines the scheduling gap 114 based on the SCS of the configured periodic CSI measurement resource, without consideration of any configured semi-persistent CSI measurement resource (e.g., the rule is independent of a configured semi-persistent CSI measurement resource). In a third option, the rule determines the scheduling gap 114 based on the SCS of the configured semi-persistent CSI measurement resource, without consideration of any configured periodic CSI measurement resource (e.g., the rule is independent of a configured periodic CSI measurement resource). In a fourth option, the rule does not consider either configured periodic or semi-persistent CSI measurement resources (e.g., the rule determines the scheduling gap 114 independently of configured periodic CSI measurement resources and configured semi-persistent CSI measurement resources). Accordingly, in some aspects, Equation 1 can be modified to include one of μ_{periodic resource} or μ_{semi-persistent resource} according to the second or the third option. In other aspects, Equation 1 can be modified to include neither of μ_{periodic resource} or μ_{semi-persistent resource} according to the fourth option. In any of these options, the rule provides certainty as to whether or which periodic or semi-persistent CSI measurement resources are considered in determining the scheduling gap 114.

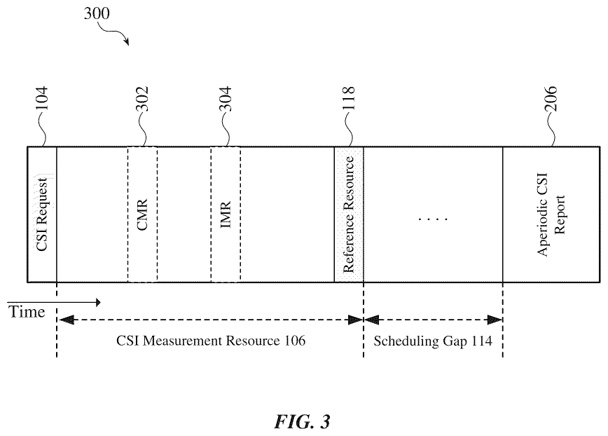

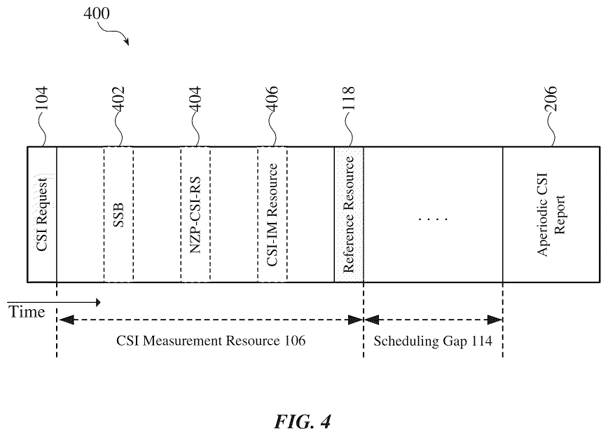

FIGS. 3-4 illustrate example timing diagrams 300, 400 for aperiodic CSI reporting with periodic or semi-persistent CSI measurement resources where the rule for determining the scheduling gap is based on whether the periodic or semi-persistent CSI measurement resources are CMR or IMR. Example timing diagrams 300, 400 show similar features as timing diagram 200 with alternative embodiments with regards to the CSI measurement resources. Example timing diagram 300 shows CSI measurement resource(s) 106 that include CMR 302 and IMR 304 CSI measurement resources. The CMR 302 and the IMR 304 can be configured as periodic or semi-persistent. The CMR 302 can be an NZP-CSI-RS for channel measurements or a SSB. The IMR 304 can be an NSP-CSI-RS for interference measurements or a CSI-IM resource. As such, the rule for determining the scheduling gap 114 can be based on one or more of a SCS of the CMR or a SCS of the IMR.

In other aspects, Z′ can be used to determine the scheduling gap 114 based on μ, and Z′ can be a function of a SCS minimum as described in Equation 2.

$$min ( {μ}_{P D C C H} , {μ}_{U L} , {μ}_{C M R} , {μ}_{I M R} ) \qquad Equation 2$$

Where μ_{CMR} is a SCS of the CMR and μ_{IMR} is a SCS of the IMR. Equation 2 is not limited in this respect, and can include the SCS of other configured CSI resources. Additionally or alternatively, the scheduling gap 114 can be based on the function

$$( {T}_{p r o c , CSI}^{′} )$$

including Z′ as described in TS 38.214, Section 5.4, Table 5.4-1 or Table 5.4-2 as discussed herein. As such, μ as described in Tables 5.4-1 and Table 5.4-2 of TS 38.214 can be modified so that Z′ may be based on the μ_{CMR} or μ_{IMR} as describe herein, and the function including Z′ described in Section 5.4 of TS 38.214 can be modified so that Z′ is based on periodic or semi-persistent CMR or periodic or semi-persistent IMR for the aperiodic CSI report 206.

The rule for determining the scheduling gap 114 can be based on the CMR 302 or the IMR 304 according to various options. In a fifth option, the rule determines the scheduling gap 114 based on both the SCS of a configured CMR and a configured IMR. In a sixth option, the rule determines the scheduling gap 114 based on the SCS of the configured CMR without consideration of any configured IMR (e.g., the rule is independent of a configured IMR). In a seventh option, the rule determines the scheduling gap 114 based on the SCS of the configured IMR, without consideration of any configured CMR (e.g., the rule is independent of a configured CMR). In an eighth option, the rule does not consider either configured IMR or CMR (e.g., the rule determines the scheduling gap 114 independently of configured CMR and IMR).

Accordingly, in some aspects, Equation 2 can be modified to include one of μ_{CMR} or μ_{IMR} according to the sixth or the seventh option. In other aspects, Equation 2 can be modified to include neither of μ_{CMR} or μ_{IMR} according to the eighth option. In any of these options, the rule provides certainty as to whether or which CMR or IMR CSI measurement resources are considered in determining the scheduling gap 114.

Example timing diagram 400 shows SSB 402, NZP-CSI-RS 404 and CSI-IM 406 CSI measurement resources where the rule for determining the scheduling gap is based on whether the periodic or semi-persistent CSI measurement resources are SSB, NZP-CSI-RS, or CSI-IM. The SSB 402, the NZP-CSI-RS 404, and CSI-IM 406 can be configured as periodic or semi-persistent. For example, the rule for determining the scheduling gap 114 can be based on one or more of a SCS of the SSB, a SCS of the NZP-CSI-RS, or a SCS of the CSI-IM.

In other aspects, Z′ can be used to determine the scheduling gap 114 based on μ, and Z′ can be a function of a SCS minimum as described in Equation 3.

$$min ( {μ}_{P D C C H} , {μ}_{U L} , {μ}_{S S B} , {μ}_{NZP CSI RS} , {μ}_{CSI IM} ) \qquad Equation 3$$

Where μ_{SSB} is the SCS of the SSB, μ_{NZP CSI RS} is the SCS of the NZP-CSI-RS, and μ_{CSI IM} is the SCS of the CSI-IM resource. Equation 3 is not limited in this respect, and can include the SCS of other configured CSI resources. Additionally or alternatively, the scheduling gap 114 can be based on the function

including Z′ as described in TS 38.214, Section 5.4, Table 5.4-1 or Table 5.4-2 as discussed herein. As such, μ as described in Tables 5.4-1 and Table 5.4-2 can be based on the μ_{SSB}, μ_{NZP CS RS}, μ_{CSI IM} as describe herein, and the function including Z′ described in Section 5.4 of TS 38.214 can be based on periodic or semi-persistent SSB or periodic or semi-persistent NZP-CSI-RS, or periodic or semi-persistent CSI-IM resource for the aperiodic CSI report 206.

The rule for determining the scheduling gap 114 can be based on the SSB 402, the NZP-CSI-RS 404, or the CSI-IM 406 resource according to various options. In a ninth option, the rule comprises determining the scheduling gap 114 based on a SCS of a selected one or more of a configured SSB, a configured NZP-CSI-RS, or a configured CSI-IM resource, and the rule is independent of a remaining one or more of the configured SSB, the configured NZP-CSI-RS, or the configured CSI-IM resource. Accordingly, in some aspects, Equation 3 can be modified to include one or more of μ_{SSB}, μ_{NZP CSI RS}, μ_{CSI IM} according to the ninth option. In other words, Equation 2 can be modified to omit one or more of μ_{SSB}, μ_{NZP CSI RS}, μ_{CSI IM} according to the ninth option. In any of these options, the rule provides certainty as to whether or which SSB, NZP-CSI-RS, or CSI-IM CSI measurement resources are considered in determining the scheduling gap 114.

In alternative aspects, in a tenth option, for aperiodic CSI reporting, the rule for determining the scheduling gap 114 may be based on a SCS of any CSI measurement resources. As such, the rule for determining the scheduling gap 114 can be based on the SCS of periodic or semi-persistent CSI measurement resources, CMR or IMR measurement resources, or SSB, NZP-CSI-RS, or CSI-IM measurement resources. Accordingly, Equation 1 can be modified to include a SCS of one or more of a periodic, semi-persistent, CMR, IMR, SSB, NZP-CSI-RS, or CSI-IM measurement resources. As such, μ as described in Tables 5.4-1 and Table 5.4-2 of TS 38.214 can be modified so that Z′ may be based on the SCS measurement resources of the tenth option, and the function including Z′ described in Section 5.4 of TS 38.214 can be modified so that Z′ is based on the SCS measurement resources of the tenth option for the aperiodic CSI report 206.

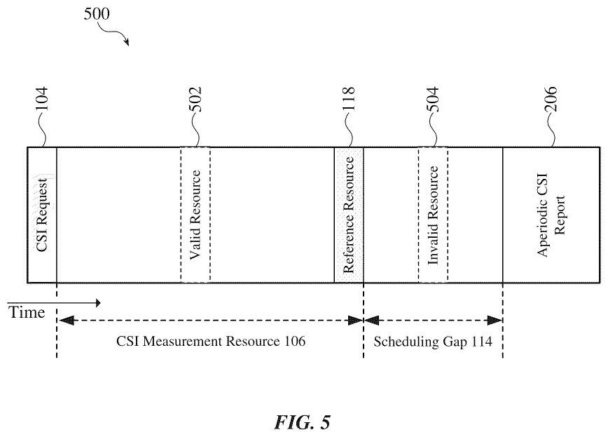

FIG. 5 illustrates a timing diagram 500 for aperiodic CSI reporting based on configured CSI measurement resources that include an invalid CSI measurement resource. The valid CSI measurement resource 502 is configured before the scheduling gap 114 while the invalid CSI measurement resource 504 is configured during the scheduling gap 114.

There are several alternatives for how the UE will respond to a CSI report configuration that configures an invalid CSI measurement resource. For example, in response to receiving the configuration of the invalid CSI measurement resource the UE may cancel the measurement of valid CSI measurement resource 502 and cancel transmission of the aperiodic CSI report 206.

Alternatively, rather than cancel all CSI measurements and reporting, in response to receiving a CSI report configuration that includes an invalid CSI measurement resource, the UE 102 can still perform CSI measurements and reporting under certain conditions. For example, the UE 102 can generate the aperiodic CSI report 206 based on the valid CSI measurement resources according to a condition. The condition can be based on the invalid CSI measurement resource 504 being a predetermined interference sensing or channel sensing measurement resource. In other aspects, the condition can be based on the invalid CSI measurement resource 504 being periodic or semi-persistent.

As such, aperiodic CSI reporting 206 has certainty in scheduling or being canceled in the presence of an invalid CSI measurement resource 504.

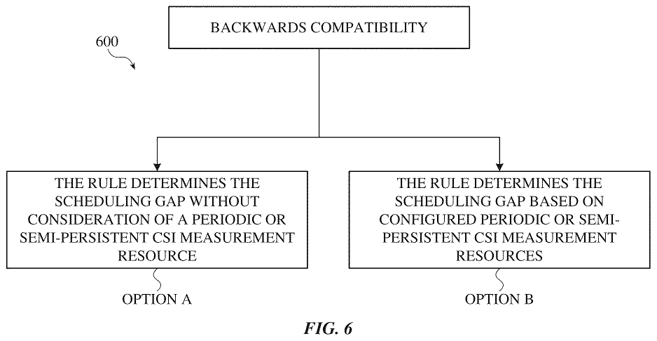

FIG. 6 illustrates a diagram 600 of an example technique for providing backward compatibility for aperiodic CSI reporting. Aspects of aperiodic CSI reporting with periodic or semi-persistent CSI measurement resources discussed herein may not be supported by legacy UEs or BSs. As such, diagram 600 shows options for backwards compatibility with legacy equipment (e.g., UEs or BSs). In Option A, the rule determines the scheduling gap (e.g., scheduling gap 114 of FIGS. 1-5), without consideration of a periodic or semi-persistent CSI measurement resource. In Option B, the rule determines the scheduling gap based on a configured one or more periodic or semi-persistent CSI measurement resources. As such, Option A may be suited for legacy equipment, and Option B may be suited for new equipment. In some examples, when Option B is implemented, the minimum function, as described in Equation 1, Equation 2, and Equation 3, can be independent of a SCS of one or more of periodic or semi-persistent CSI measurement resources. When Option A is implemented, the minimum function, as described in Equation 1, Equation 2, and Equation 3, can include one or more of the periodic or semi-persistent CSI measurement resources, as described in accordance with FIGS. 1-5. Option A or Option B can be chosen according to the examples described below.

In a first example, the UE 102 determines a UE capability for indicating operation in a first mode that supports Option A, or a second mode that supports Option B. That is, in the first mode, the rule for determining the scheduling gap is independent of a configured periodic CSI measurement resource and independent of a configured semi-persistent CSI measurement resource. In the second mode, the rule for determining the scheduling gap is based on one or more of a configured periodic CSI measurement resource or a configured semi-persistent CSI measurement resource. The UE 102 transmits a message (e.g., RRC) indicating operation in either the first mode or the second mode. The first mode or the second mode can be related to or indicated by a release of the 3GPP standards under which the UE is operating. For example, the first mode can relate to a release of the 3GPP standards that do not support aperiodic CSI reporting with periodic or semi-persistent CSI measurement resources. The second mode can relate to a release of the 3GPP standards that does support aperiodic CSI reporting with periodic or semi-persistent CSI measurement resources. The UE 102 can perform CSI measurements and reporting according to Option A or Option B based on the UE capability.

In a second example, the UE 102 can be configured for Option A or Option B based on a network implementation. That is, the rule determines the scheduling gap based on the network implementation of Option A or Option B.

In a third example, the UE 102 can be preconfigured with one of Option A or Option B.

In a fourth example, the rule that determines the scheduling gap 114 is based on a cellular standard configuration (e.g., 3GPP standard and release) of the UE 102 including a legacy cellular standard or a new cellular standard. When the UE does not support the new cellular standard, and only supports the legacy cellular standard, the UE 102 implements Option A. That is, the rule is independent of a configured periodic CSI measurement resource and independent of a configured semi-persistent CSI measurement resource. When the UE supports the new cellular standard, the rule comprises determining the scheduling gap according to Option B. That is, the rule is based on a SCS of one or more of a configured periodic CSI measurement resource or a SCS of a configured semi-persistent CSI measurement resource.

In a fifth example, the UE 102 can receive RRC signaling indicating operation according to Option A or Option B. That is, the RRC signaling can indicate a first mode in which the rule for determining the scheduling gap is independent of a configured periodic CSI measurement resources and a configured semi-persistent CSI measurement resource. Or the RRC signaling can indicate a second mode in which the rule for determining the scheduling gap is based on a configured periodic CSI measurement resource or a configured semi-persistent CSI measurement resource. As such, the scheduling gap is based on the RRC signaling.

In a sixth example, the rule is based on a UE capability for supporting aperiodic CSI reporting with periodic CSI measurement resources or with semi-persistent CSI measurement resources. When the UE capability supports aperiodic CSI reporting with periodic CSI measurement resources or semi-persistent CSI measurement resources, the UE 102 can implement Option B. When the UE capability does not support aperiodic CSI reporting with periodic CSI measurement resources or semi-persistent CSI measurement resources, the UE 102 can implement Option A.

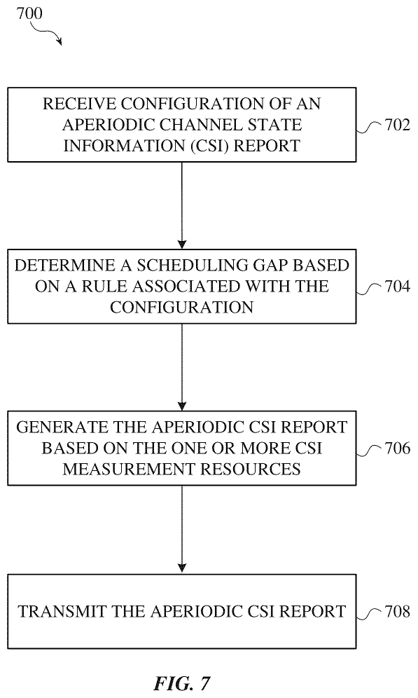

FIG. 7 is a flow diagram outlining an example method 700 by which a UE performs aperiodic CSI reporting. The example method 700 may be performed, for example, by the UE 102 of FIG. 1.

At 702, the method includes receiving configuration of an aperiodic CSI report, where the configuration indicates one or more CSI measurement resources that comprise one or more of a periodic CSI measurement resource or a semi-persistent CSI measurement resource. The configuration can indicate one or more of the CSI measurement resources recited in accordance with FIGS. 1-5.

At 704, the method includes determining a scheduling gap based on a rule associated with the configuration. The scheduling gap is a minimum time period between receiving the one or more CSI measurement resources and transmitting the aperiodic CSI report. The rule can be based on one or more of the rules discussed in accordance with FIGS. 1-5. Furthermore, the method may include determining a reference resource associated with the aperiodic CSI report based on the scheduling gap.

At 706, the method includes generating the aperiodic CSI report based on the one or more CSI measurement resources.

At 708, the method includes transmitting the aperiodic CSI report according to the configuration.

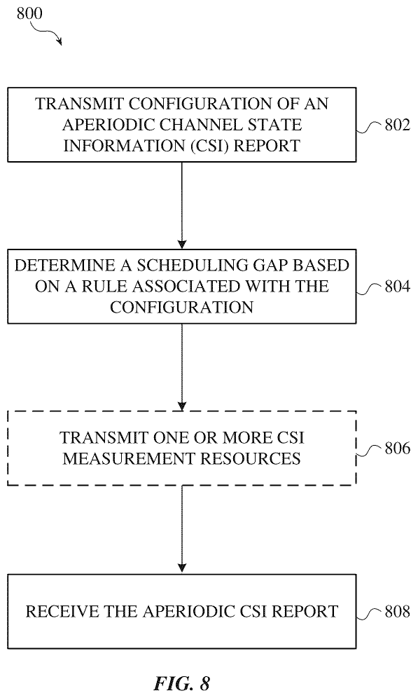

FIG. 8 is a flow diagram outlining an example method 800 by which a BS performs configures aperiodic CSI reporting. The example method 800 may be performed, for example, by the BS 112 of FIG. 1.

At 802, the method includes transmitting configuration of an aperiodic CSI report, where the configuration indicates one or more CSI measurement resources that comprise one or more of a periodic CSI measurement resource or a semi-persistent CSI measurement resource. The configuration can indicate one or more of the CSI measurement resources recited in accordance with FIGS. 1-5.

At 804, the method includes determining a scheduling gap based on a rule associated with the configuration. The scheduling gap is a minimum time period between a scheduled timing of the one or more one or more CSI measurement resources and receiving the aperiodic CSI report. The rule can be based on one or more of the rules discussed in accordance with FIGS. 1-5. Furthermore, the method may include determining a reference resource associated with the aperiodic CSI report based on the scheduling gap.

At 806, the method optionally includes transmitting the one or more CSI measurement resources before the scheduling gap.

At 808, the method includes receiving the aperiodic CSI report.

FIG. 9 is a diagram of an example of components of a device according to one or more implementations described herein. In some implementations, the device 900 can include application circuitry 902, baseband circuitry 904, RF circuitry 906, front-end module (FEM) circuitry 908, one or more antennas 910, and power management circuitry (PMC) 912 coupled together at least as shown. The components of the illustrated device 900 can be included in a UE or a BS, or a radio access network (RAN) node. In some implementations, the device 900 can include fewer elements (e.g., a RAN node may not utilize application circuitry 902, and instead include a processor/controller to process IP data received from a CN or an Evolved Packet Core (EPC)). In some implementations, the device 900 can include additional elements such as, for example, memory/storage, display, camera, sensor (including one or more temperature sensors, such as a single temperature sensor, a plurality of temperature sensors at different locations in device 900, etc.), or input/output (I/O) interface. In other implementations, the components described below can be included in more than one device (e.g., said circuitries can be separately included in more than one device for Cloud-RAN (C-RAN) implementations).

The application circuitry 902 can include one or more application processors. For example, the application circuitry 902 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 900. In some implementations, processors of application circuitry 902 can process IP data packets received from an EPC.

The baseband circuitry 904 can include circuitry such as, but not limited to, one or more single-core or multi-core processors. The baseband circuitry 904 can include one or more baseband processors or control logic to process baseband signals received from a receive signal path of the RF circuitry 906 and to generate baseband signals for a transmit signal path of the RF circuitry 906. Baseband circuitry 904 can interface with the application circuitry 902 for generation and processing of the baseband signals and for controlling operations of the RF circuitry 906. For example, in some implementations, the baseband circuitry 904 can include a 3G baseband processor 904A, a 4G baseband processor 904B, a 5G baseband processor 904C, or other baseband processor(s) 904D for other existing generations, generations in development or to be developed in the future (e.g., 5G, 6G, etc.). The baseband circuitry 904 (e.g., one or more of baseband processors 904A-D) can handle various radio control functions that enable communication with one or more radio networks via the RF circuitry 906. In other implementations, some or all of the functionality of baseband processors 904A-D can be included in modules stored in the memory 904G and executed via a Central Processing Unit (CPU) 904E. The radio control functions can include, but are not limited to, signal modulation/demodulation, encoding/decoding, radio frequency shifting, etc. In some implementations, modulation/demodulation circuitry of the baseband circuitry 904 can include Fast-Fourier Transform (FFT), precoding, or constellation mapping/de-mapping functionality. In some implementations, encoding/decoding circuitry of the baseband circuitry 904 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, baseband circuitry 904 may receive, store, generate, or transmit one or more configurations, instructions, and/or other types of information to enable CSI related operations and communications. For a UE, the baseband circuitry 904 may receive a CSI request, receive or measure CSI measurement resources, and transmit a CSI report. For a BS, the baseband circuitry 904 may transmit the CSI request, optionally transmit CSI measurement resources, and receive a CSI report. The CSI request can include a CSI configuration for receiving or configuring aperiodic or semi-persistent CSI measurement resources. Furthermore, the baseband circuitry 904 may determine a scheduling gap between a reference resource and a scheduled aperiodic CSI report.

The baseband circuitry 904 may include one or more audio digital signal processor(s) (DSP) 904F. The audio DSPs 904F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 904 and the application circuitry 902 can be implemented together such as, for example, on a system on a chip (SOC).

In some implementations, the baseband circuitry 904 can provide for communication compatible with one or more radio technologies. For example, in some implementations, the baseband circuitry 904 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 904 is configured to support radio communications of more than one wireless protocol can be referred to as multi-mode baseband circuitry.

RF circuitry 906 can enable communication with wireless networks using modulated electromagnetic radiation through a non-solid medium. In various implementations, the RF circuitry 906 can include switches, filters, amplifiers, etc. to facilitate the communication with the wireless network. RF circuitry 906 can include a receive signal path which can include circuitry to down-convert RF signals received from the FEM circuitry 908 and provide baseband signals to the baseband circuitry 904. RF circuitry 906 can also include a transmit signal path which can include circuitry to up-convert baseband signals provided by the baseband circuitry 904 and provide RF output signals to the FEM circuitry 908 for transmission.

In some implementations, the receive signal path of the RF circuitry 906 can include mixer circuitry 906A, amplifier circuitry 906B and filter circuitry 906C. In some implementations, the transmit signal path of the RF circuitry 906 can include filter circuitry 906C and mixer circuitry 906A. RF circuitry 906 can also include synthesizer circuitry 906D for synthesizing a frequency for use by the mixer circuitry 906A of the receive signal path and the transmit signal path. In some implementations, the mixer circuitry 906A of the receive signal path can be configured to down-convert RF signals received from the FEM circuitry 908 based on the synthesized frequency provided by synthesizer circuitry 906D. The amplifier circuitry 906B can be configured to amplify the down-converted signals and the filter circuitry 906C can be a low-pass filter (LPF) or band-pass filter (BPF) configured to remove unwanted signals from the down-converted signals to generate output baseband signals. Output baseband signals can be provided to the baseband circuitry 904 for further processing. In some implementations, the output baseband signals can be zero-frequency baseband signals, although this is not a requirement.

In some implementations, mixer circuitry 906A of the receive signal path can comprise passive mixers, although the scope of the implementations is not limited in this respect.

In some implementations, the mixer circuitry 906A of the transmit signal path can be configured to up-convert input baseband signals based on the synthesized frequency provided by the synthesizer circuitry 906D to generate RF output signals for the FEM circuitry 908. The baseband signals can be provided by the baseband circuitry 904 and can be filtered by filter circuitry 906C.

In some implementations, the mixer circuitry 906A of the receive signal path and the mixer circuitry 906A of the transmit signal path can include two or more mixers and can be arranged for quadrature down conversion and up conversion, respectively. In some implementations, the mixer circuitry 906A of the receive signal path and the mixer circuitry 906A of the transmit signal path can include two or more mixers and can be arranged for image rejection (e.g., Hartley image rejection). In some implementations, the mixer circuitry 906A of the receive signal path and the mixer circuitry 906A can be arranged for direct down conversion and direct up conversion, respectively. In some implementations, the mixer circuitry 906A of the receive signal path and the mixer circuitry 906A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 906 can include analog-to-digital converter (ADC) and digital-to-analog converter (DAC) circuitry and the baseband circuitry 904 can include a digital baseband interface to communicate with the RF circuitry 906.

In some dual-mode implementations, a separate radio IC circuitry can be provided for processing signals for each spectrum, although the scope of the implementations is not limited in this respect.

In some implementations, the synthesizer circuitry 906D can be a fractional-N synthesizer or a fractional N/N+1 synthesizer, although the scope of the implementations is not limited in this respect as other types of frequency synthesizers can be suitable. For example, synthesizer circuitry 906D can be a delta-sigma synthesizer, a frequency multiplier, or a synthesizer comprising a phase-locked loop with a frequency divider.

The synthesizer circuitry 906D can be configured to synthesize an output frequency for use by the mixer circuitry 906A of the RF circuitry 906 based on a frequency input and a divider control input. In some implementations, the synthesizer circuitry 906D can be a fractional N/N+1 synthesizer.

In some implementations, frequency input can be provided by a voltage-controlled oscillator (VCO), although that is not a requirement. Divider control input can be provided by either the baseband circuitry 904 or the applications circuitry 902 depending on the desired output frequency. In some implementations, a divider control input (e.g., N) can be determined from a look-up table based on a channel indicated by the applications circuitry 902.

Synthesizer circuitry 906D of the RF circuitry 906 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 906D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 906 can include an IQ/polar converter.

FEM circuitry 908 can include a receive signal path which can include circuitry configured to operate on RF signals received from one or more antennas 910, amplify the received signals and provide the amplified versions of the received signals to the RF circuitry 906 for further processing. FEM circuitry 908 can also include a transmit signal path which can include circuitry configured to amplify signals for transmission provided by the RF circuitry 906 for transmission by one or more of the one or more antennas 910. In various implementations, the amplification through the transmit or receive signal paths can be done solely in the RF circuitry 906, solely in the FEM circuitry 908, or in both the RF circuitry 906 and the FEM circuitry 908.

In some implementations, the FEM circuitry 908 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 906). The transmit signal path of the FEM circuitry 908 can include a power amplifier (PA) to amplify input RF signals (e.g., provided by RF circuitry 906), and one or more filters to generate RF signals for subsequent transmission (e.g., by one or more of the one or more antennas 910).

In some implementations, the PMC 912 can manage power provided to the baseband circuitry 904. In particular, the PMC 912 can control power-source selection, voltage scaling, battery charging, or DC-to-DC conversion. The PMC 912 can often be included when the device 900 is capable of being powered by a battery, for example, when the device is included in a UE. The PMC 912 can increase the power conversion efficiency while providing desirable implementation size and heat dissipation characteristics.

While FIG. 9 shows the PMC 912 coupled only with the baseband circuitry 904. However, in other implementations, the PMC 912 may be additionally or alternatively coupled with, and perform similar power management operations for, other components such as, but not limited to, application circuitry 902, RF circuitry 906, or FEM circuitry 908.

In some implementations, the PMC 912 can control, or otherwise be part of, various power saving mechanisms of the device 900. For example, if the device 900 is in an RRC_Connected state, where it is still connected to the RAN node as it expects to receive traffic shortly, then it can enter a state known as discontinuous reception mode (DRX) after a period of inactivity. During this state, the device 900 can power down for brief intervals of time and thus save power.

If there is no data traffic activity for an extended period of time, then the device 900 can transition off to an RRC_Idle state, where it disconnects from the network and does not perform operations such as channel quality feedback, handover, etc. The device 900 goes into a very low power state and it performs paging where again it periodically wakes up to listen to the network and then powers down again. The device 900 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 902 and processors of the baseband circuitry 904 can be used to execute elements of one or more instances of a protocol stack. For example, processors of the baseband circuitry 904, alone or in combination, can be used execute Layer 3, Layer 2, or Layer 1 functionality, while processors of the baseband circuitry 904 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

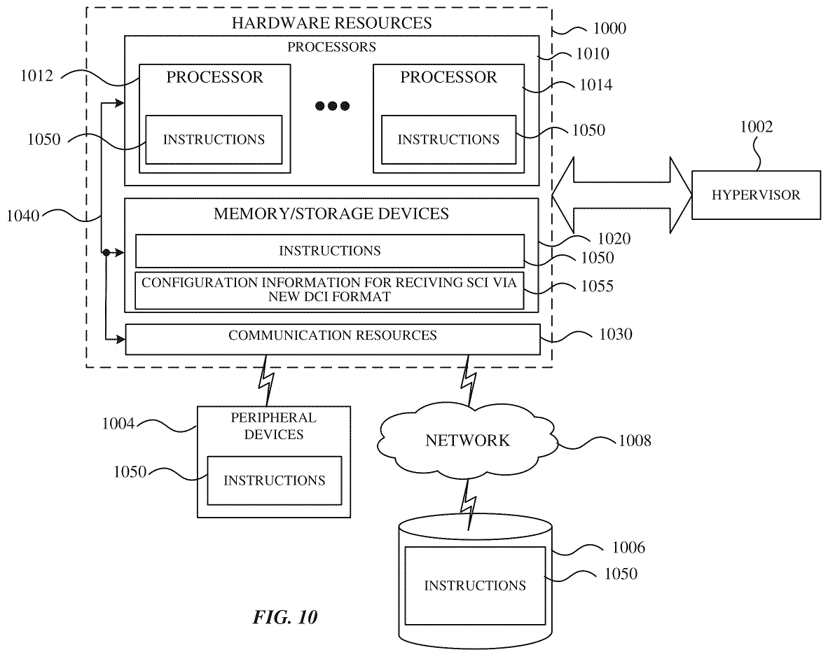

FIG. 10 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including processors 1010 (i.e., one or more processors or processor cores), memory/storage devices 1020 (or one or more memory/storage devices), and one or more communication resources 1030, each of which may be communicatively coupled via a bus 1040. For implementations where node virtualization (e.g., NFV) is utilized, a hypervisor may be executed to provide an execution environment for one or more network slices/sub-slices to utilize the hardware resources 1000

The processors 1010 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1012 and a processor 1014.

The memory/storage devices 1020 may include main memory, disk storage, or any suitable combination thereof. The memory/storage devices 1020 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, processors 1010 in conjunction with memory/storage devices 1020 may receive, store, generate, or transmit one or more configurations, instructions, and/or other types of information to enable CSI related operations and communications. For a UE, the processors 1010 in conjunction with memory/storage devices 1020 may receive a CSI request, receive or measure CSI measurement resources, and transmit a CSI report. For a BS, the processors 1010 in conjunction with memory/storage devices 1020 may transmit the CSI request, optionally transmit CSI measurement resources, and receive a CSI report. The CSI request can include a CSI configuration for receiving or configuring aperiodic or semi-persistent CSI measurement resources. Furthermore, the processors 1010 may determine a scheduling gap between a reference resource and a scheduled aperiodic CSI report.

The communication resources 1030 may include interconnection or network interface components or other suitable devices to communicate with one or more peripheral devices 1004 or one or more databases 1006 via a network 1008. For example, the communication resources 1030 may include wired communication components (e.g., for coupling via a universal serial bus (USB)), cellular communication components, NFC components, Bluetooth® components (e.g., Bluetooth® low energy), Wi-Fi® components, and other communication components.

Instructions 1050 may comprise software, a program, an application, an applet, an app, or other executable code for causing at least any of the processors 1010 to perform any one or more of the methodologies discussed herein. The instructions 1050 may reside, completely or partially, within at least one of the processors 1010 (e.g., within the processor's cache memory), the memory/storage devices 1020, or any suitable combination thereof. Furthermore, any portion of the instructions 1050 may be transferred to the hardware resources 1000 from any combination of the peripheral devices 1004 or the databases 1006. Accordingly, the memory of processors 1010, the memory/storage devices 1020, the peripheral devices 1004, and the databases 1006 are examples of computer-readable and machine-readable media.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

Example 1 is a user equipment (UE), comprising: a memory; and one or more processors configured to, when executing instructions stored in the memory, cause the UE to: receive configuration of an aperiodic channel state information (CSI) report, wherein the configuration indicates one or more CSI measurement resources that comprise one or more of a periodic CSI measurement resource or a semi-persistent CSI measurement resource; determine a scheduling gap based on a rule associated with the configuration, wherein the scheduling gap is a minimum time period between receiving the one or more CSI measurement resources and transmitting the aperiodic CSI report; generate the aperiodic CSI report based on CSI measurement resources of the one or more CSI measurement resources received prior to the scheduling gap; and transmit the aperiodic CSI report according to the configuration.

Example 2 includes Example 1, wherein the rule comprises determining the scheduling gap based on one or more of a subcarrier spacing (SCS) of the one or more CSI measurement resources.

Example 3 includes Example 2 wherein the one or more CSI measurement resources include one or more of a channel measurement resource (CMR), an interference measurement resource (IMR), a synchronization signal block (SSB), a non-zero-power (NZP) CSI reference signal (NZP-CSI-RS), or a CSI interference measurement (CSI-IM) resource.

Example 4 includes Example 1, wherein the rule comprises determining the scheduling gap based on a subcarrier spacing (SCS) of a configured periodic CSI measurement resource, and the rule is independent of a configured semi-persistent CSI measurement resource.

Example 5 includes Example 1, wherein the rule comprises determining the scheduling gap based on a subcarrier spacing (SCS) of a configured semi-persistent CSI measurement resource, and the rule is independent of a configured periodic CSI measurement resource.

Example 6 includes Example 1, wherein the rule comprises determining the scheduling gap independently of a configured periodic CSI measurement resource and a configured semi-persistent CSI measurement resource.

Example 7 includes Example 1, wherein the one or more CSI measurement resources include one or more of a channel measurement resource (CMR) or an interference measurement resource (IMR).

Example 8 includes Example 7, wherein the rule comprises determining the scheduling gap based on a subcarrier spacing (SCS) of a configured CMR, and the rule is independent of a configured IMR.

Example 9 includes Example 7, wherein the rule comprises determining the scheduling gap based on a subcarrier spacing (SCS) of a configured IMR, and the rule is independent of the CMR.

Example 10 includes Example 1, wherein the rule comprises determining the scheduling gap based on a subcarrier spacing (SCS) of a selected one or more of a configured synchronization signal block (SSB), a configured non-zero-power (NZP) CSI resource (NZP-CSI-RS), or a configured CSI interference measurement resource (CSI-IM) resource and the rule is independent of a remaining one or more of the configured SSB, the configured NZP-CSI-RS, or the configured CSI-IM resource.

Example 11 includes Example 1, wherein the one or more processors are configured to: determine a UE capability for indicating operation in a first mode in which the rule is independent of a configured periodic CSI measurement resource and independent of a configured semi-persistent CSI measurement resource or a second mode in which the rule comprises determining the scheduling gap based on a configured periodic CSI measurement resource and a configured semi-persistent CSI measurement resource; and transmit a message indicating operation in either the first mode or the second mode.

Example 12 includes Example 1, wherein the rule comprises determining the scheduling gap based on a network implementation.

Example 13 includes Example 1, wherein the rule is based on a cellular standard configuration of the UE including a legacy cellular standard or a new cellular standard, wherein when the UE does not support the new cellular standard, and only supports the legacy cellular standard, the rule is independent of a configured periodic CSI measurement resource and independent of a configured semi-persistent CSI measurement resource; and when the UE supports the new cellular standard, the rule comprises determining the scheduling gap based on a subcarrier spacing (SCS) of a configured periodic CSI measurement resource and a SCS of a configured semi-persistent CSI measurement resource.

Example 14 includes Example 1, wherein the one or more processors are configured to: receive a radio resource control (RRC) signaling indicating operation in a first mode in which the rule is independent of a configured periodic CSI measurement resources and a configured semi-persistent CSI measurement resource or a second mode in which the rule comprises determining the scheduling gap based on a configured periodic CSI measurement resource or a configured semi-persistent CSI measurement resource; and determine the scheduling gap based on the RRC signaling.

Example 15 includes Example 1, wherein the rule is based on a UE capability for supporting aperiodic CSI reporting with periodic CSI measurement resource or with semi-persistent CSI measurement resource.

Example 16 includes Example 1, wherein the one or more processors are further configured to: cancel scheduled measurement of the one or more CSI measurement resources and cancel the transmission of the aperiodic CSI report in response to receiving configuration of an invalid CSI measurement resource that is scheduled during the scheduling gap.

Example 17 includes Example 1, wherein the one or more processors are further configured to: receive configuration of an invalid CSI measurement resource that is scheduled during the scheduling gap; and transmit the aperiodic CSI report based on the one or more CSI measurement resources received before the scheduling gap when the invalid CSI measurement resource is related to a predetermined one of interference sensing or channel sensing.

Example 18 includes Example 1, wherein the one or more processors are further configured to: receive configuration of an invalid CSI measurement resource that is scheduled during the scheduling gap; and transmit the aperiodic CSI report based on the one or more CSI measurement resources received before the scheduling gap when the invalid CSI measurement resource is periodic or semi-persistent.

Example 19 is a method for a base station (BS), comprising: generating, based on a scheduling gap, a configuration for an aperiodic channel state information (CSI) report that indicates one or more CSI measurement resources comprising one or more of a periodic CSI measurement resource or a semi-persistent CSI measurement resource, wherein the scheduling gap is determined based on a rule and corresponds to a minimum time period between the one or more CSI measurement resources and a transmission time of the aperiodic CSI report; and transmitting the configuration of the aperiodic CSI report and the one or more CSI measurement resources.

Example 20 includes Example 19, further comprising: generating, one or more of the CSI measurement resources; and transmitting the one or more CSI measurement resources prior to the scheduling gap; and receive the aperiodic CSI report in response transmitting the configuration of the aperiodic CSI report.

Example 21 includes Example 19, wherein the rule comprises determining the scheduling gap based on one or more of a subcarrier spacing (SCS) of the one or more CSI measurement resources.

Example 22 includes Example 21, wherein the one or more CSI measurement resources include one or more of a channel measurement resource (CMR), an interference measurement resource (IMR), a synchronization signal block (SSB), a non-zero-power (NZP) CSI reference signal (NZP-CSI-RS), or a CSI interference measurement (CSI-IM) resource.

Example 23 includes Example 19, wherein the rule comprises determining the scheduling gap based on a subcarrier spacing (SCS) of a configured periodic CSI measurement resource, and the rule is independent of a configured semi-persistent CSI measurement resource.

Example 24 includes Example 19, wherein the rule comprises determining the scheduling gap based on a subcarrier spacing (SCS) of a configured semi-persistent CSI measurement resource, and the rule is independent of a configured periodic CSI measurement resource.

Example 25 includes Example 19, wherein the rule comprises determining the scheduling gap independently of a configured periodic CSI measurement resource and a configured semi-persistent CSI measurement resource.

Example 26 includes Example 19, wherein the one or more CSI measurement resources include one or more of a channel measurement resource (CMR) or an interference measurement resource (IMR).

Example 27 includes Example 26, wherein the rule comprises determining the scheduling gap based on a subcarrier spacing (SCS) of a configured CMR, and the rule is independent of a configured IMR.

Example 28 includes Example 26, wherein the rule comprises determining the scheduling gap based on a subcarrier spacing (SCS) of a configured IMR, and the rule is independent of the CMR.

Example 29 includes Example 19, wherein the rule comprises determining the scheduling gap based on a subcarrier spacing (SCS) of a selected one or more of a configured synchronization signal block (SSB), a configured non-zero-power (NZP) CSI resource (NZP-CSI-RS), or a configured CSI interference measurement resource (CSI-IM) resource and the rule is independent of a remaining one or more of the configured SSB, the configured NZP-CSI-RS, or the configured CSI-IM resource.

Example 30 includes Example 19, further comprising: receiving a user equipment (UE) capability for indication a first mode in which the rule is independent of a configured periodic CSI measurement resource and independent of a configured semi-persistent CSI measurement resource or a second mode in which the rule comprises determining the scheduling gap based on a configured periodic CSI measurement resource and a configured semi-persistent CSI measurement resource.

Example 31 includes Example 19, wherein the rule comprises determining the scheduling gap based on a network implementation.

Example 32 includes Example 19, wherein the rule is based on a cellular standard configuration of a user equipment (UE) including a legacy cellular standard or a new cellular standard, wherein when the UE does not support the new cellular standard, and only supports the legacy cellular standard, the rule is independent of a configured periodic CSI measurement resource and independent of a configured semi-persistent CSI measurement resource; and when the UE supports the new cellular standard, the rule comprises determining the scheduling gap based on a subcarrier spacing (SCS) of a configured periodic CSI measurement resource and a SCS of a configured semi-persistent CSI measurement resource.

Example 33 includes Example 19, further configured to: transmit a radio resource control (RRC) signaling indicating operation in a first mode in which the rule is independent of a configured periodic CSI measurement resources and a configured semi-persistent CSI measurement resource or a second mode in which the rule comprises determining the scheduling gap based on a configured periodic CSI measurement resource or a configured semi-persistent CSI measurement resource; and determine the scheduling gap based on the RRC signaling.

Example 34 includes Example 19, wherein the rule is based on a user equipment (UE) capability for supporting aperiodic CSI reporting with periodic CSI measurement resource or with semi-persistent CSI measurement resource.

Example 35 includes Example 19, further configured to transmit one or more CSI measurement resources during the scheduling gap.

Example 36 is a method for a base station (BS), comprising: generating, based on a scheduling gap, a configuration for an aperiodic channel state information (CSI) report that indicates one or more CSI measurement resources comprising one or more of a periodic CSI measurement resource or a semi-persistent CSI measurement resource, wherein the scheduling gap is determined based on a rule and corresponds to a minimum time period between the one or more CSI measurement resources and a transmission time of the aperiodic CSI report; transmitting the configuration of the aperiodic CSI report and the one or more CSI measurement resources; generating at least one of the one or more CSI measurement resources; and transmitting the at least one of the one or more CSI measurements before the scheduling gap, or during the scheduling gap.

A method as substantially described herein with reference to each or any combination substantially described herein, comprised in examples 1-36, and in the Detailed Description.

A non-transitory computer readable medium as substantially described herein with reference to each or any combination substantially described herein, comprised in examples 1-36, and in the Detailed Description.

A wireless device configured to perform any action or combination of actions as substantially described herein, comprised in examples 1-36, and in the Detailed Description.

An integrated circuit configured to perform any action or combination of actions as substantially described herein, comprised in examples 1-36, and in the Detailed Description.

An apparatus configured to perform any action or combination of actions as substantially described herein, comprised in examples 1-36, and in the Detailed Description.

A baseband processor configured to perform any action or combination of actions as substantially described herein, comprised in examples 1-36, and in the Detailed Description.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

1. A user equipment (UE), comprising:
a memory; and
one or more processors configured to, when executing instructions stored in the memory, cause the UE to:
receive configuration of an aperiodic channel state information (CSI) report, wherein the configuration indicates one or more CSI measurement resources that comprise one or more of a periodic CSI measurement resource or a semi-persistent CSI measurement resource;
determine a scheduling gap based on a rule associated with the configuration, wherein the scheduling gap is a minimum time period between receiving the one or more CSI measurement resources and transmitting the aperiodic CSI report;
generate the aperiodic CSI report based on CSI measurement resources of the one or more CSI measurement resources received prior to the scheduling gap; and
transmit the aperiodic CSI report according to the configuration.

2. The UE of claim 1, wherein the rule comprises determining the scheduling gap based on one or more of a subcarrier spacing (SCS) of the one or more CSI measurement resources.

3. The UE of claim 2, wherein the one or more CSI measurement resources include one or more of a channel measurement resource (CMR), an interference measurement resource (IMR), a synchronization signal block (SSB), a non-zero-power (NZP) CSI reference signal (NZP-CSI-RS), or a CSI interference measurement (CSI-IM) resource.

4. The UE of claim 1, wherein the rule comprises determining the scheduling gap based on a subcarrier spacing (SCS) of a configured periodic CSI measurement resource, and the rule is independent of a configured semi-persistent CSI measurement resource.

5. The UE of claim 1, wherein the rule comprises determining the scheduling gap based on a subcarrier spacing (SCS) of a configured semi-persistent CSI measurement resource, and the rule is independent of a configured periodic CSI measurement resource.

6. The UE of claim 1, wherein the rule comprises determining the scheduling gap independently of a configured periodic CSI measurement resource and a configured semi-persistent CSI measurement resource.

7. The UE of claim 1, wherein the one or more CSI measurement resources include one or more of a channel measurement resource (CMR) or an interference measurement resource (IMR).

8. The UE of claim 7, wherein the rule comprises determining the scheduling gap based on a subcarrier spacing (SCS) of a configured CMR, and the rule is independent of a configured IMR.

9. The UE of claim 7, wherein the rule comprises determining the scheduling gap based on a subcarrier spacing (SCS) of a configured IMR, and the rule is independent of the CMR.

10. The UE of claim 1, wherein the rule comprises determining the scheduling gap based on a subcarrier spacing (SCS) of a selected one or more of a configured synchronization signal block (SSB), a configured non-zero-power (NZP) CSI resource (NZP-CSI-RS), or a configured CSI interference measurement resource (CSI-IM) resource and the rule is independent of a remaining one or more of the configured SSB, the configured NZP-CSI-RS, or the configured CSI-IM resource.

11. The UE of claim 1, wherein the one or more processors are configured to:
determine a UE capability for indicating operation in a first mode in which the rule is independent of a configured periodic CSI measurement resource and independent of a configured semi-persistent CSI measurement resource or a second mode in which the rule comprises determining the scheduling gap based on a configured periodic CSI measurement resource and a configured semi-persistent CSI measurement resource; and
transmit a message indicating operation in either the first mode or the second mode.

12. The UE of claim 1, wherein the rule comprises determining the scheduling gap based on a network implementation.

13. The UE of claim 1, wherein the rule is based on a cellular standard configuration of the UE including a legacy cellular standard or a new cellular standard,
wherein when the UE does not support the new cellular standard, and only supports the legacy cellular standard, the rule is independent of a configured periodic CSI measurement resource and independent of a configured semi-persistent CSI measurement resource; and
when the UE supports the new cellular standard, the rule comprises determining the scheduling gap based on a subcarrier spacing (SCS) of a configured periodic CSI measurement resource and a SCS of a configured semi-persistent CSI measurement resource.

14. The UE of claim 1, wherein the one or more processors are configured to:
receive a radio resource control (RRC) signaling indicating operation in a first mode in which the rule is independent of a configured periodic CSI measurement resources and a configured semi-persistent CSI measurement resource or a second mode in which the rule comprises determining the scheduling gap based on a configured periodic CSI measurement resource or a configured semi-persistent CSI measurement resource; and
determine the scheduling gap based on the RRC signaling.

15. The UE of claim 1, wherein the rule is based on a UE capability for supporting aperiodic CSI reporting with periodic CSI measurement resource or with semi-persistent CSI measurement resource.

16. The UE of claim 1, wherein the one or more processors are further configured to:
cancel scheduled measurement of the one or more CSI measurement resources and cancel the transmission of the aperiodic CSI report in response to receiving configuration of an invalid CSI measurement resource that is scheduled during the scheduling gap.

17. The UE of claim 1, wherein the one or more processors are further configured to:
receive configuration of an invalid CSI measurement resource that is scheduled during the scheduling gap; and
transmit the aperiodic CSI report based on the one or more CSI measurement resources received before the scheduling gap when the invalid CSI measurement resource is related to a predetermined one of interference sensing or channel sensing.

18. The UE of claim 1, wherein the one or more processors are further configured to:
receive configuration of an invalid CSI measurement resource that is scheduled during the scheduling gap; and
transmit the aperiodic CSI report based on the one or more CSI measurement resources received before the scheduling gap when the invalid CSI measurement resource is periodic or semi-persistent.

19. A method for a base station (BS), comprising:
generating, based on a scheduling gap, a configuration for an aperiodic channel state information (CSI) report that indicates one or more CSI measurement resources comprising one or more of a periodic CSI measurement resource or a semi-persistent CSI measurement resource,
wherein the scheduling gap is determined based on a rule and corresponds to a minimum time period between the one or more CSI measurement resources and a transmission time of the aperiodic CSI report; and
transmitting the configuration of the aperiodic CSI report and the one or more CSI measurement resources.

20. The method of claim 19, further comprising:
generating, one or more of the CSI measurement resources; and
transmitting the one or more CSI measurement resources prior to the scheduling gap; and
receive the aperiodic CSI report in response transmitting the configuration of the aperiodic CSI report.

21.-36. (canceled)
